(19) United States
(12) Patent Application Publication
(10) Pub. No.: US 2008/0260451 A1
(43) Pub. Date: Oct. 23, 2008

(54) Lotion dispenser

(76) Inventor: Felix Caron, Mansonville (CA)

Correspondence Address: Eric Fincham, 316 Knowlton Road, Lac Brome, Quebec, J0E 1V0, CA

(21) Appl. No.: 12/148,449

(22) Filed: Apr. 18, 2008

(30) Foreign Application Priority Data
Apr. 19, 2007 (CA) 2,585,397

(51) Int. Cl. B43K 5/06; B65D 37/00; G01F 11/00

(52) U.S. Cl. 401/188 R; 222/207; 222/256; 401/176

(57) ABSTRACT

A container having a body surrounding a cavity and with lotion within the cavity, a mouth formed in the body and communicating with the cavity, and a dispenser located in the mouth. The dispenser comprises a pump base at a bottom end of the dispenser, a foraminous member located in an upper end of the dispenser, a first hollow piston extending from the base and a second hollow piston mounted on the foraminous member and disposed coaxially with respect to the first hollow piston, and a bellows surrounding the second piston and operative to urge away from the first piston upon release of an external actuating force on the foraminous member.

### FIELD OF THE INVENTION

The present invention relates to a dispenser and more particularly, relates to a dispenser suitable for dispensing a lotion on the skin of the user. The invention also relates to a method for dispensing a lotion.

### BACKGROUND OF THE INVENTION

The concept of applying a lotion to the skin of a user is well known and has been practiced for many years. The particular lotion to be dispensed can vary from including utilitarian ones such as deodorants, antiperspirants, sun screens, etc. Also, many fragrances are applied by means of a different type of dispenser such as sprays etc.

The dispensers themselves range from one wherein manual application is required (in the case of the lotion being stored in a container) to dispensers such a roll ons deodorant sticks, spray containers, pump dispensers etc. Each one of the known dispensers has particular advantages and disadvantages associated therewith.

### SUMMARY OF THE INVENTION

It is an object of the present invention to provide for a novel dispenser suitable for applying certain lotions to the skin of the user.

According to one aspect of the present invention, there is provided a container having a body surrounding a cavity, a lotion within the cavity, a mouth formed in the body, the mouth communicating with the cavity, a dispenser located in the mouth, the dispenser comprising, a pump base at a bottom end of the dispenser, a foraminous member located at an upper end of the dispenser, a first hollow piston extending from the base and a second hollow piston mounted on the foraminous member and disposed coaxially with respect to the first hollow piston, a bellows surrounding the second piston and operative to urge away from the first piston upon release of an external actuating force on the foraminous member.

According to a further aspect of the present invention, there is provided a method of dispensing a lotion on the skin of the user comprising the step of supplying a container having a body surrounding a cavity, a lotion within the container, a mouth formed in the body, the mouth communicating with the cavity, a dispenser located in the mouth, the dispenser comprising a pump base at a bottom end of the dispenser, a foraminous member located at an upper end of the dispenser, a first hollow piston extending from the base and a second hollow piston mounted on said foraminous member and disposed coaxially to the first hollow piston, a bellows surrounding the second piston and operative to urge the second piston away from the piston upon release of an external actuating force upon the foraminous member, and a cover extending over the mouth and the dispenser, removing the cover from the container, pressing on the foraminous member to dispense lotion from the container.

The container of the present invention is similar to those found in other uses, primarily for spray dispensing. Thus, there is provided a pump device with a return force by means of a spring arrangement. Conveniently, the spring arrangement comprises a bellows.

The present invention utilizes a foraminous member which is mounted on top of the dispenser. This foraminous member may be formed of any suitable material and preferably is of a plastic material to provide suitable feel when the dispenser is used. Thus, the dispenser is intended for use wherein the container is placed on the skin of the user and pushed to activate the pump. The material is then dispensed through the foraminous housing and may be spread by the container itself.

The type of lotion being dispensed may vary and thus, may include materials such as deodorants, antiperspirants, skin lotions, etc.

### BRIEF DESCRIPTION OF THE DRAWINGS

Having thus generally described the invention, reference will be made to the accompanying drawing illustrating an embodiment thereof, in which:

FIG. 1 is a cross-sectional view of a dispenser in accordance with the present invention.

### DETAILED DESCRIPTION OF THE INVENTION

A dispenser which is generally designated by reference numeral 8 has a housing 10 which is in the form of a cylinder. Interiorly of the cylinder there is provided a storage portion 12 into which the fluid to be dispensed is placed.

Mounted interiorly of the housing 10 at the upper portion thereof is a pump generally designated by reference numeral 14. Pump 14 includes a piston 16 which is moveable in the dispensing direction towards the upper portion of the dispenser 8. Sealing flanges 18 are provided on the base member 20. Base member 20 includes a plug 22 which permits the dispensing of the material within the storage portion 12.

Pump 14 comprises hollow pistons 24 and 26 which are arranged axially and can be displaced axially with respect to each other.

Piston 26 functions as a stationary cylinder which extends from a cover 28 on top of the housing 10. It includes annular wall 30 which extends below the level of cover 28 and which has a base 32. An upwardly directed collar 36 extends from base 32.

An inlet valve generally designated by reference numeral 34 is seated in collar 36. Inlet valve 36 is of the disk type with a top side level and bottom side cross-shaped shaft 38 and which is secured by outwardly directed hooks 40. The upper rim of collar 36 has a thermal shaped valve seat 42.

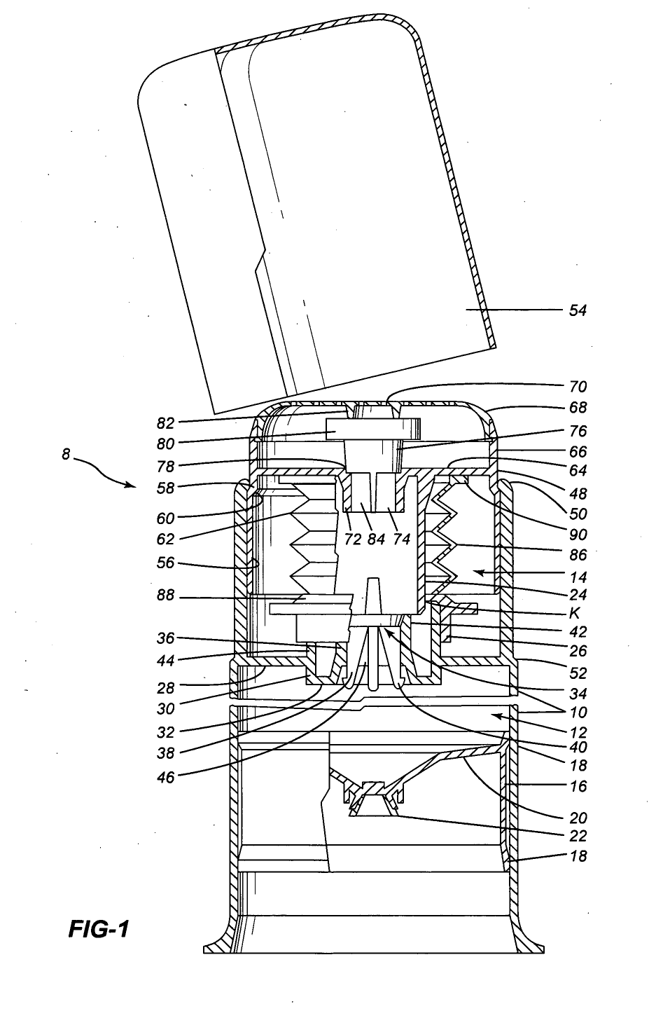

As will be seen from FIG. 1, collar 14 terminates in front of a rim 44 of piston 26.

The arrangement provides a central passage 46 in collar 36 to permit the passage of the lotion from storage portion 12.

An upper portion 48 of pump 14 is associated with the bottom of piston 24. Thus, there is a cup shaped portion 50 which extends beyond cover 28 of housing 10 in an upward direction. The cup shaped portion 50 is slightly recessed with respect to the cylindrical wall of housing 10 such that an annular shoulder 52 is formed. A lower edge of a cap 54 comes against the annular shoulder 52 as a stop.

Upper portion 48 of pump 14 includes a guide section 56 which slides over the inner surface of cup shaped portion 50. The axial movement of the pump stroke is limited by stops in both directions. In this respect, a stop in the actuating direction is the result of cover 28 abutting against the lower front edge of guide section 56. In the opposite direction, the stop limitation is formed in the abuttment of an internal annular collar 58 on the upper free end of guide section 56 wherein the annular collar 58 cooperates with an annular shoulder 60.

The sprung activated position is provided by a spring action which comprises a spring bellows generally designated by reference numeral 62. Spring bellows 62 biases the pistons 24 and 26 away from each other.

Upper portion 48 of pump 14 includes a horizontal wall 64 which terminates with an upwardly directed vertical collar 66. At the top, there is provided a dispensing top 68 which has a plurality of apertures 70 formed therein to permit the application of the lotion to the skin of a user.

A central collar 72 extends at a distance from the inner surface of piston 24 and guides a shaft 74 on an outlet valve 76. Central collar 72 starts directly below horizontal wall 64 and forms a valve seat 78. The axially longer valve disk of outlet valve 76 will rise with its lower edge in a normal position with a sealing on valve seat 78. Outlet valve 76 is known in the art and has an upper collar 80 extending against vertical walls 82 which extend from the cover of dispensing top 68. Upper collar 80 has openings in its bottom section extending beyond the circumferential walls so that lotion can freely pass therethrough. Upper collar 80 is supported on top so that the lower rim edge of the valve disk rests against valve seat 78 in a sealing application under spring pressure. The central passage 84 of outlet valve 76 connects the passageway of the valve structure to apertures 70.

Bellows 62 form the restoring spring action. As will be seen, bellows 62 has folds 86 formed therein in a traditional manner. Preferably bellows 62 is formed of a plastic material. An end fold 88 of bellows 62 extends outwardly for sealing purposes.

At the lower end of bellows 62, there is provided a piston ring 92 which slides on the wall surface. Piston ring 92 is of greater thickness than the thickness of the wall of the bellows.

It will be understood that the above described embodiment is for purposes of illustration only and that changes and modifications may be made thereto without departing from the spirit and scope of the invention.

I claim:

1. A container having a body surrounding a cavity, a lotion within said cavity, a mouth formed in said body, said mouth communicating with said cavity, a dispenser located in said mouth, said dispenser comprising:
a pump base at a bottom end of said dispenser;
a foraminous member located at an upper end of said dispenser;
a first hollow piston extending from said base and a second hollow piston mounted on said foraminous member and disposed coaxially with respect to said first hollow piston;
a bellows surrounding said second piston and operative to urge away from said first piston upon release of an external actuating force on said foraminous member.

2. A container as defined in claim 1 wherein said lotion comprises a body lotion.

3. The container of claim 1 wherein said body lotion comprises a deodorant.

4. The container of claim 2 wherein said lotion comprises an antiperspirant.

5. The container of claim 1 further including a cap designed to fit over said foraminous member and said dispenser.

6. A method of dispensing a lotion on the skin of the user comprising the steps of:
supplying a container having a body surrounding a cavity, a lotion within said container, a mouth formed in said body, said mouth communicating with said cavity, a dispenser located in said mouth, said dispenser comprising a pump base at a bottom end of said dispenser, a foraminous member located at an upper end of said dispenser, a first hollow piston extending from said base and a second hollow piston mounted on said foraminous member and disposed coaxially to said first hollow piston, a bellows surrounding said second piston and operative to urge said second piston away from said first piston upon release of an external actuating force upon said foraminous member, and a cover extending over said mouth and said dispenser;
removing said cover from said container;
pressing on said foraminous member to dispense lotion from said container.
